(19) United States
(12) Patent Application Publication
(10) Pub. No.: US 2013/0169649 A1
(43) Pub. Date: Jul. 4, 2013

(54) MOVEMENT ENDPOINT EXPOSURE

(71) Applicants: Megan A. Bates, Kirkland, WA (US); Song Zou, Bellevue, WA (US); Shaojie Zhang, Bellevue, WA (US); Ross N. Luengen, Sammamish, WA (US)

(72) Inventors: Megan A. Bates, Kirkland, WA (US); Song Zou, Bellevue, WA (US); Shaojie Zhang, Bellevue, WA (US); Ross N. Luengen, Sammamish, WA (US)

(73) Assignee: MICROSOFT CORPORATION, Redmond, WA (US)

(21) Appl. No.: 13/343,638

(22) Filed: Jan. 4, 2012

(51) Int. Cl. G06T 13/00

(52) U.S. Cl. 345/473

(57) ABSTRACT

Movement endpoint exposure techniques are described. In one or more implementations, an input is received by a computing device to cause output of an animation involving movement in a user interface. Responsive to the receipt of the input, an endpoint is exposed to software of the computing device that is associated with the user interface, such as applications and controls. The endpoint references a particular location in the user interface at which the animation is calculated to end for the input.

### BACKGROUND

Users have a variety of different ways with which to navigate through a user interface. For example, a user may interact with keys of a keyboard such as “page up” or “page down” to navigate up and down through a user interface, respectively. A user may also utilize a cursor control device, such as scroll wheel of a “mouse,” to move up and down or left and right in the user interface. A variety of other examples are also available to the user, such as gestures and so on.

However, conventional techniques that were utilized to display movement corresponding to this navigation could be unpredictable and lead to an incomplete user experience. For example, conventional techniques that involved movement having inertia, such as a “flick,” to move through a user interface could be unpredictable in that there was no way beforehand to determine “where” the movement would stop in the user interface. This unpredictability could result in efficient use of resources of the computing device. Further, the movement could result in navigation that resulted in partial display of items, which could be disconcerting to users and result in further inefficiencies, such as to involve corrective inputs to view an entirety of the items.

### SUMMARY

Movement endpoint exposure techniques are described. In one or more implementations, an input is received by a computing device to cause output of an animation involving movement in a user interface. Responsive to the receipt of the input, an endpoint is exposed to software of the computing device that is associated with the user interface, such as applications and controls. The endpoint references a particular location in the user interface at which the animation is calculated to end for the input.

In one or more implementations, a system includes an input device and one or more modules implemented at least partially in hardware and communicatively coupled to the input device. The one or more modules configured to recognize an input detected using the input device as a gesture that is configured to initiate an animation involving movement in a user interface, calculate an endpoint that describes a particular location in the user interface at which the movement is to end for the input, and expose the calculated input to software that is associated with causing the user interface to be generated.

In one or more implementations, one or more computer-readable storage media comprise computer-executable instructions that, responsive to execution on a computing device, causes the computing device to recognize an input as a gesture configured to cause output of an animation involving movement having inertia and responsive to the recognition of the input, initiate output of the animation for display in a user interface by the computing device and expose an endpoint for the animation to software associated with generating the user interface, the endpoint describing a particular location in the user interface at which the movement is to end for the animation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ movement endpoint exposure techniques.

FIG. 2 is an illustration of an example implementation in which a user interface of FIG. 1 is shown in greater detail.

FIG. 3 is an illustration of an example implementation in which an end result of an animation applied to the user interface of FIG. 2 is output.

FIG. 4 is an illustration of an example implementation in which another end result of an animation applied to the user interface of FIG. 2 is output.

FIG. 5 is a flow diagram depicting a procedure in an example implementation in which an endpoint for an animation involving movement in a user interface is exposed.

FIG. 6 illustrates an example system that includes the computing device as described with reference to FIG. 1.

FIG. 7 illustrates various components of an example device that can be implemented as any type of computing device as described with reference to FIGS. 1, 2, and 6 to implement embodiments of the techniques described herein.

### DETAILED DESCRIPTION

Overview

Conventional techniques that employed animations to show movement in a user interface (e.g., panning in response to a touch gesture) did not provide a mechanism by which to determine an endpoint of the movement of the animation outside of the animation itself. Thus, applications, controls, and other software that leveraged use of the animation were left “in the dark” regarding an end result of the animation. This lack of knowledge could result in inefficient loading and rendering of content, temporary blank sections on the screen due to continued fetching and rendering of content and resultant consumption of resources of the computing device, result in a partial view of items, and so forth.

Movement endpoint exposure techniques are described. In one or more implementations, an endpoint for an animation involving movement is exposed for use by software associated with the user interface in which the movement is to be applied, such as to applications, controls, and so on. The animation, for instance, may be configured to support touch panning that involves an amount of inertia, such as in response to a flick in which the user interface continues to move after input of the flick.

An endpoint of the animation may be exposed to the software associated with the user interface, which may be leveraged to support a variety of functionality. This may include preparation for arriving at the location in the user interface corresponding to the endpoint, such as to fetch and prioritize content to be displayed at the endpoint, adjust the endpoint (e.g., so an item that otherwise would have been cut off is instead displayed in its entirety), and so forth. In this way, efficiency in the user of resources of the computing device as well as a user experience itself may be improved. Further discussion of these techniques may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

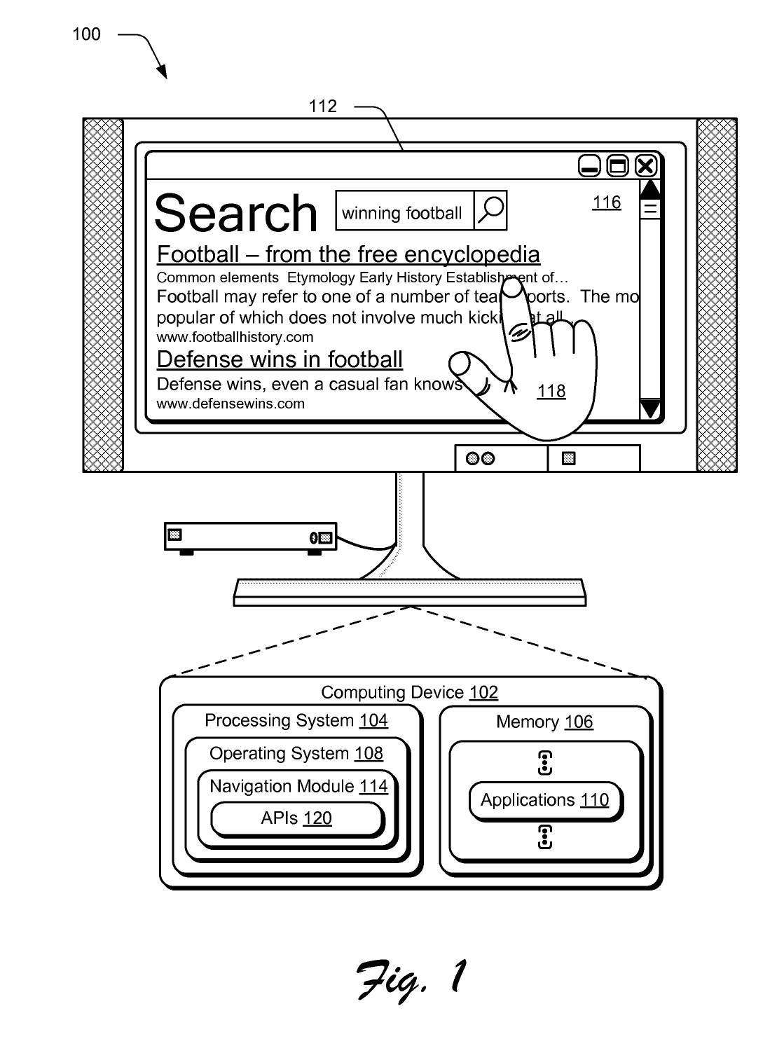

FIG. 1 is an illustration of an environment 100 in an example implementation that is operable to employ movement endpoint exposure techniques described herein. The illustrated environment 100 includes a computing device 102, which may be configured in a variety of ways. For example, the computing device 102 may be configured as a desktop computer, a mobile station, an entertainment appliance, a set-top box communicatively coupled to a display device, a wireless phone, a slate (e.g., a tablet), a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as a remote control and set-top box combination, an image capture device and a game console configured to capture gestures, and so on.

The computing device 102 is also illustrated as including a processing system 104 and memory 106. The processing system 104 is representative of functionality of the computing device 102 to perform one or more operations, such as through execution of instructions, configuration as one or more functional blocks, implemented “in silicon” such as through an application specific integrated circuit, and so on as further described in the discussion of modules below.

The computing device 102 is further illustrated as including an operating system 108. The operating system 108 is configured to abstract underlying functionality of the computing device 102 to applications 110 that are executable on the computing device 102. For example, the operating system 108 may abstract the processing system 104, memory 106, network, and/or display functionality (e.g., a display device 112) of the computing device 102 such that the applications 110 may be written without knowing “how” this underlying functionality is implemented. The application 110, for instance, may provide data to the operating system 108 to be rendered and displayed by the display device 112 without understanding how this rendering will be performed. The operating system 108 may also represent a variety of other functionality, such as to manage a file system and user interface that is navigable by a user of the computing device 102.

The operating system 108 is also illustrated as including a navigation module 114. The navigation module 114 is representative of functionality to navigate through a user interface 116 output for display on a display device 112. The illustrated user interface 116, for instance, is configured to include search results in an amount that is greater than can be displayed on the display device at any one time. Accordingly, the navigation module 114 may support techniques that may be used to navigate through the user interface 116 to view portions of interest.

This navigation may be performed in a variety of ways. For example, the computing device 102 may receive one or more inputs from a user, such as through detection of a gesture made by a user's hand 120. The gesture may be detected in a variety of ways, such as through touch functionality (e.g., of the display device 112 and/or track pad), detected using a camera, and so on. A variety of other inputs are also contemplated, such as through a keyboard, cursor control device (e.g., mouse), and other hardware devices.

Regardless of the input technique used, the navigation module 114 may initiate an animation to display movement in the user interface 116 responsive to identification of the input. As previously described, however, conventional techniques executed the animation without providing feedback to other software associated with the user interface 116, such as an application 110 that provides content for rendering, controls of the application 110 or other software (e.g., operating system 108), and so on. Therefore, conventional techniques could result in efficient processing and rendering of content in the user interface 116, output of an undesirable endpoint, and so on.

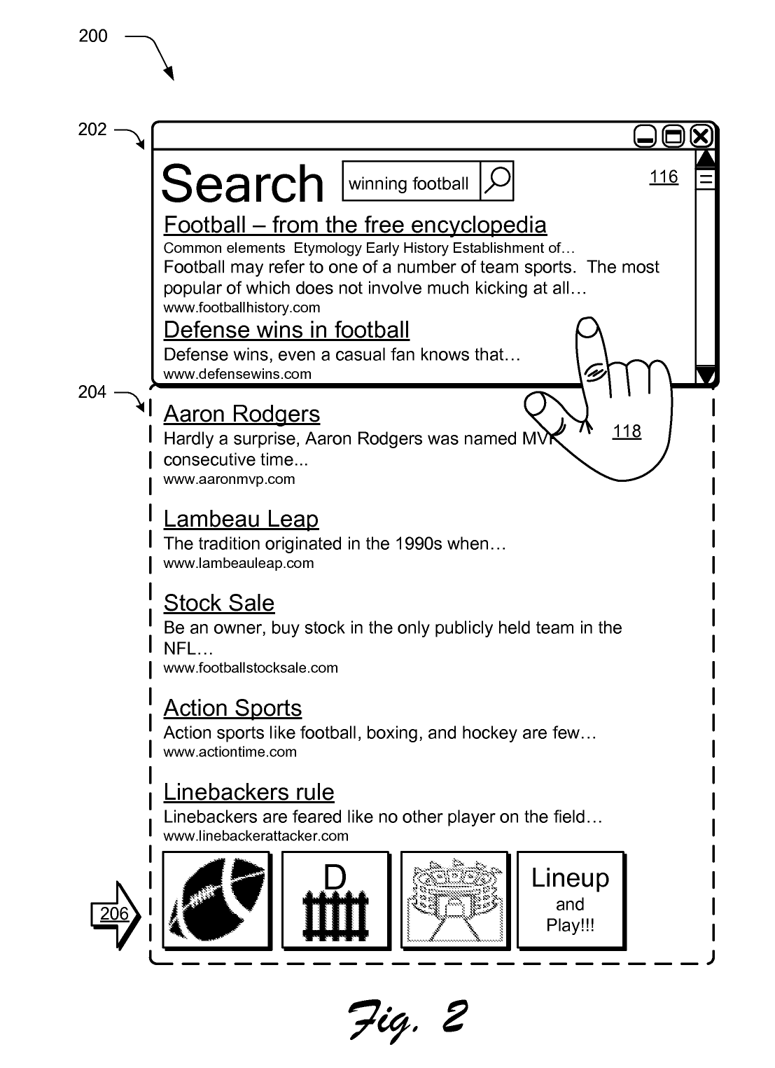

In one or more implementations, the navigation module 114 is configured to expose an endpoint of the movement of the animation, such as through one or more application programming interfaces 120 although other exposure techniques are also contemplated. Additionally, this exposure may be performed by the navigation module 114 before the endpoint is output for display by the display device 112, and thus may be leveraged to support a wide variety of functionality, further discussion of which may be found beginning in relation to FIG. 2.

Generally, any of the functions described herein can be implemented using software, firmware, hardware (e.g., fixed logic circuitry), or a combination of these implementations. The terms “module,” “functionality,” and “engine” as used herein generally represent software, firmware, hardware, or a combination thereof. In the case of a software implementation, the module, functionality, or engine represents program code that performs specified tasks when executed on a processor (e.g., CPU or CPUs) and is storable in one or more computer readable storage devices and thus is implementable at least partially in hardware. The features of the techniques described below are platform-independent, meaning that the techniques may be implemented on a variety of commercial computing platforms having a variety of processors.

For example, a computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of an example implementation 200 in which the user interface 116 of FIG. 1 is shown in greater detail. The user interface 116 in this example is shown having first and second sections 202, 204. The first section 202 represents an amount of the user interface 116 that is displayable at any one point in time, e.g., in a current window and/or by the display device 112 at a given magnification.

Accordingly, the first section 202 is illustrated in a box as being currently displayed by the display device 112, whereas the second section 204 is illustrated in phantom. In this example, an input is received during the display of the first section 202. As previously described, this may be performed in a variety of ways, such as by recognizing a touch gesture (e.g., a flick) made by one or more fingers of the user's hand 118 although other input techniques are also contemplated.

The movement involved in this example may involve inertia such that the movement may continue even after the provision of the input is stopped. For example, the finger of the user's hand 118 may be placed against the display device 112 and flicked upward. The movement module 114 may then recognize this gesture and cause output of a corresponding animation to navigate downward in the user interface 116. Further, this movement may continue even after the movement of the finger of the user's hand 118 has stopped and thus the movement in the animation involves inertia.

Initiation of the animation may then cause display of the second portion 204 to begin in this example. This may be performed in a variety of ways, such as to display a scrolling animation in which parts of the second portion 204 are moved “onscreen” for display on the display device 112 as parts of the first portion 202 are moved “off screen.” Thus, in this example, parts of the second portion 204 are used to replace parts of the first portion 202 during the animation. It should be readily apparent that a wide variety of other examples of animations involving movement are also contemplated (e.g., a fade in/out) as well as different amounts that may be involved in the movement, e.g., such as to keep a part of the first portion 202 displayed with a part of the second portion 204 and so on.

In this example, the movement module 114 exposes an endpoint of the animation, which is illustrated through use of an arrow 206 in the example implementation 200. This exposure may be performed in a variety of ways, such as through one or more APIs 120 of the movement module 114 to software associated with the user interface 116, such as software associated with providing content rendered in the user interface 116 (e.g., applications 110), controls, and so on. The APIs 120, for instance, may follow a pull model in which the APIs 120 are configured to support queries made by the software during output of the animation. A variety of other examples are also contemplated, such as push models for the APIs 120. This exposure may be leveraged to provide a wide variety of functionality, an example of which is described in relation to the following figure.

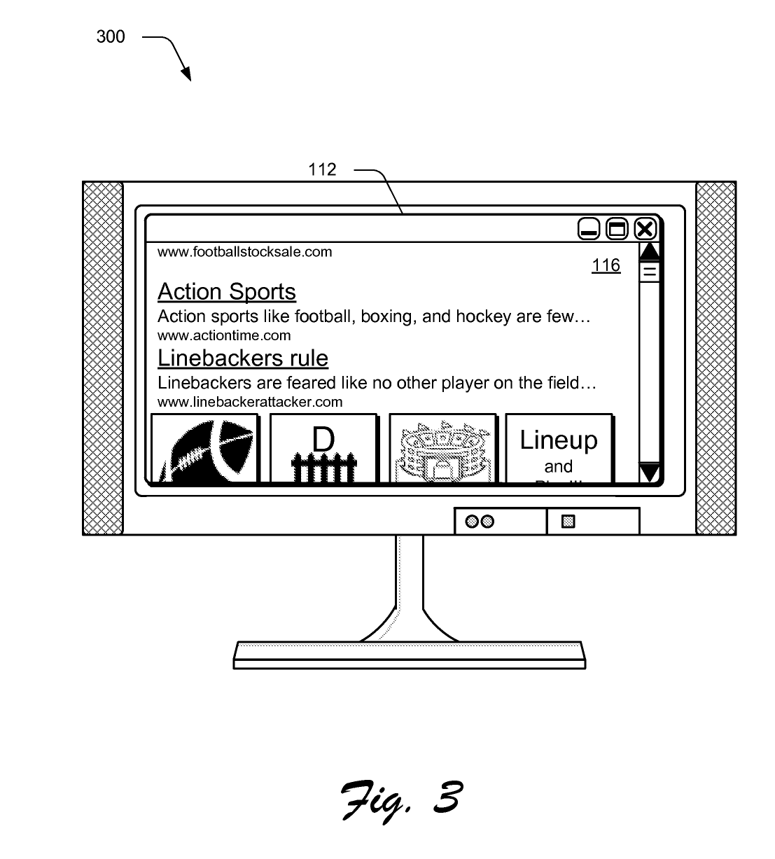

FIG. 3 depicts an example implementation 300 showing output of an endpoint of an animation involving movement as described in relation to FIG. 2. In this example, a user interface 116 that includes the endpoint illustrated through use of the arrow 206 in FIG. 2 is shown. By exposing this endpoint, such as to an application 110 that provides content for rendering in the user interface 116, the application 110 may “know ahead of time” information regarding at which point in the user interface 116 the movement will stop. In this example, the application 110 may prioritize fetching and rendering of the content associated with the end point in the user interface 116. In this way, resources of the computing device 102 may be efficiently used to output the content having increased interest.

Additional techniques may also be applied to improve efficiency in the consumption of the resources of the computing device 102 to output the animation. For example, as shown through comparison of the user interfaces 116 of FIGS. 2 and 3, portions of the user interface may be displayed for a relatively small amount of time, if at all. An example of this includes the portions of the user interface 116 disposed between the first portion 202 of FIG. 2 and the final result shown in FIG. 3, e.g., the portions of the user interface that include “Aaron Rodgers” and “Lambeau Leap.” Accordingly, the movement module 114 may output these portions as part of the animation to utilize fewer resources (e.g., lower resolution), skip rendering of all or a part of these portions, and so on. Thus, resources of the computing device 102 may be conserved and/or a user experience improved by exposing the endpoint of the animation. Other functionality may also make use of this exposure, an example of which may be found in relation to the following figure.

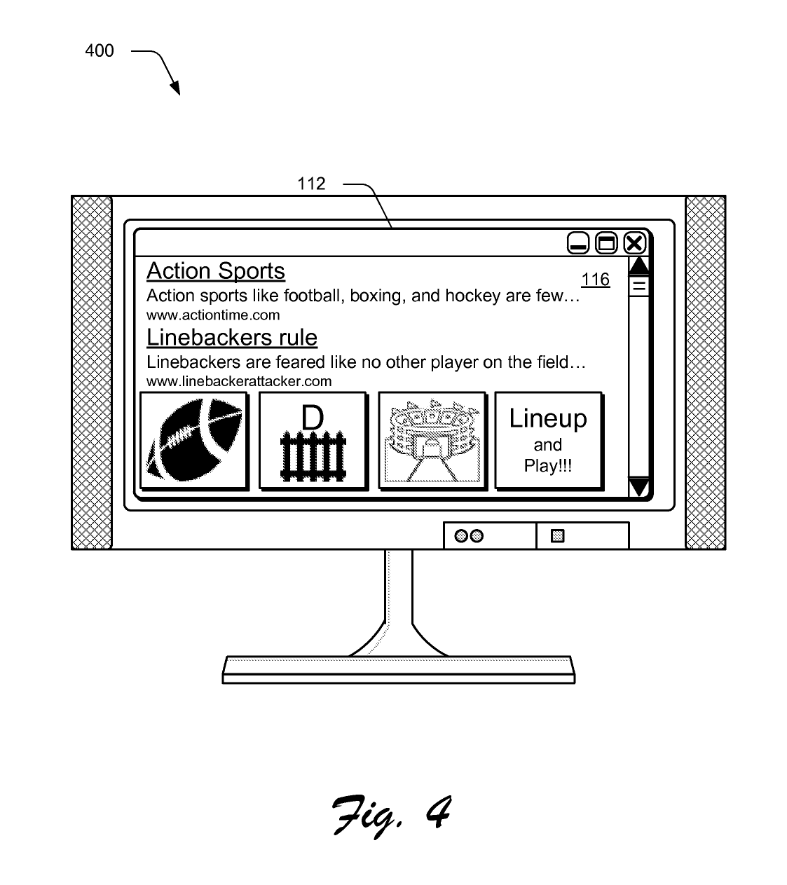

FIG. 4 depicts an example implementation 400 showing output of an endpoint of an animation initiated at FIG. 2 that has been adjusted responsive to data received from software associated with the user interface. In this example, the exposure of the endpoint is used to adjust “where” the animation will end in the user interface. For example, referring back to FIG. 2 the movement module 114 may calculate the endpoint indicated by the arrow 206 based on the input, such as direction and magnitude (e.g., speed and/or distance) involved in the gesture. However, as shown in the user interface 118 of FIG. 3 the result of this animation, without adjustment, causes partial items to be displayed in the user interface, which are images as part of an image search in this example.

In this example, however, the exposure of the endpoint may be used to adjust “where” the animation will end in the user interface. The movement module 114, for instance, may expose the endpoint calculated for the input (e.g., the arrow 206) to a browser application that provides content for output in the user interface 116. This exposure may be performed before the endpoint in the animation is reached, e.g., after initiation of the animation but before the endpoint is displayed, before initiation of the animation, and so forth.

The browser application in this example may then determine that the endpoint is not desirable (e.g., it may “cut off” a portion of the content) and therefore provide data back to the movement module 114 to adjust the endpoint. In this example, the endpoint is moved downward such that an entirety of the items (the images in the image search result) is displayed in the user interface 116 as shown in FIG. 4.

In this way, exposure of endpoint by the movement module 114 may be used to dynamically create snap points. Further, this may be utilized to conserve resources of the computing device 102, such as to address instances in which creation of a multitude of snap points would impractical due to the resources consumed in doing so. The techniques described herein, however, may be used to dynamically create snap points associated with the endpoint of the content while the animation is out, e.g., is “in motion.” Although search results were described, it should be readily apparent that the snap points may be used for a variety of other applications and controls, such as create snap points at the edge of cells near an endpoint in a spreadsheet, album titles, and so on. Further, although display of an entirety of an item was described, it should be readily apparent that the snap points may be positioned in a variety of other places as desired, such as to display half an item (e.g., a representation of an album cover), a title portion of a tile, and so forth.

Although examples of techniques that leverage exposure of an endpoint such as prioritizing fetching and rendering of content and adjustment of the endpoint were described, it should be readily apparent that a wide variety of other functionality may also leverage this exposure without departing from the spirit and scope thereof. For example, other functionality may also be employed to leverage the time between exposure of the endpoint and display of the endpoint as part of the animation to perform one or more actions. Additional discussion of movement endpoint exposure techniques may be found in relation to the following procedure.

Example Procedure

The following discussion describes movement animation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the example implementations 200, 300, 400 of FIGS. 2-4, respectively.

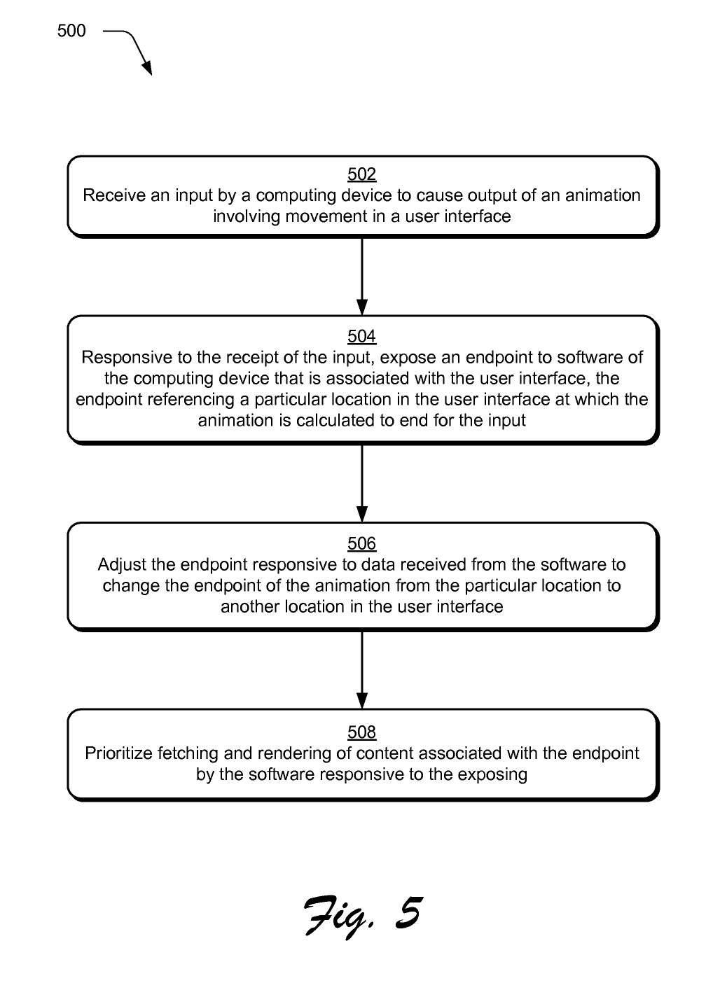

FIG. 5 depicts a procedure 500 in an example implementation in which an endpoint is exposed for an animation to software that is associated with a user interface. An input is received by a computing device to cause output of an animation involving movement in a user interface (block 502). As previously described, a variety of different inputs may be detected, such as a gesture detected using touchscreen functionality or a camera, a keyboard input, an input from a cursor control device, and so on. Additionally, the movement of the animation may be configured in a variety of ways, such as to involve inertia such that the movement continues even after provision of the input is stopped, e.g., the movement does not strictly follow a touch input across the display device 112, although other examples are also contemplated.

Responsive to the receipt of the input, an endpoint is exposed to software of the computing device that is associated with the user interface, the endpoint referencing a particular location in the user interface at which the animation is calculated to end for the input (block 504). A variety of different software may be associated with the user interface, such as software that provides content for inclusion in the user interface 116, software involved with controls that are output in the user interface 116, and so on. As previously described, this exposure may be used to support a variety of different functionality.

In one example, the endpoint is adjusted responsive to data received from the software to change the endpoint of the animation from the particular location to another location in the user interface (block 506). For instance, snap points may be dynamically defined to coincide with desired portions in the user interface, such as at an edge of cell in a spreadsheet, to ensure that a recognizable portion of an image is displayed, between sections in content, and so forth.

In another example, fetching and rendering of content associated with the endpoint is prioritized by the software responsive to the exposure of the endpoint (block 508). The application and/or control, for instance, may initiate fetching of content associated with the endpoint such that this content is rendered and displayed efficiently, e.g., without blank portions due to incomplete rendering as was encountered using conventional techniques. Further, the prioritization may be performed such that intermediate portions that are not to remain displayed (e.g., during a scroll) or even displayed at all may be skipped, rendered in a manner to reduce resource consumption (e.g., at a reduced resolution), and so on. A variety of other examples are also contemplated without departing from the spirit and scope thereof.

Example System and Device

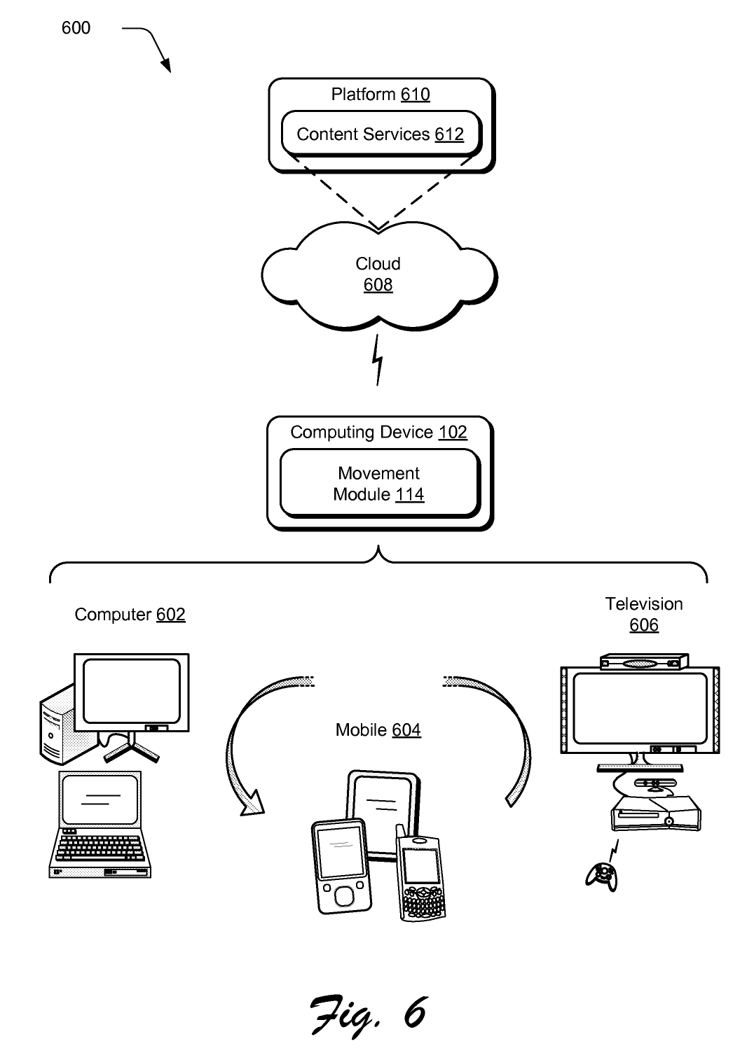

FIG. 6 illustrates an example system 600 that includes the computing device 102 as described with reference to FIG. 1. The example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 602, mobile 604, and television 606 uses. Each of these configurations includes devices that may have generally different constructs and capabilities, and thus the computing device 102 may be configured according to one or more of the different device classes. For instance, the computing device 102 may be implemented as the computer 602 class of a device that includes a personal computer, desktop computer, a multi-screen computer, laptop computer, netbook, and so on.

The computing device 102 may also be implemented as the mobile 604 class of device that includes mobile devices, such as a mobile phone, portable music player, portable gaming device, a tablet computer, a multi-screen computer, and so on. The computing device 102 may also be implemented as the television 606 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein. This is illustrated through inclusion of the movement module 114 on the computing device 102. However, it should be readily apparent that the techniques described herein may be implemented in whole or in part by a distributed environment, such as in the cloud 508 by a platform 510 support by the cloud as described below.

The cloud 608 includes and/or is representative of a platform 610 for content services 612. The platform 610 abstracts underlying functionality of hardware (e.g., servers) and software resources of the cloud 608. The content services 612 may include applications and/or data that can be utilized while computer processing is executed on servers that are remote from the computing device 102. Content services 612 can be provided as a service over the Internet and/or through a subscriber network, such as a cellular or Wi-Fi network.

The platform 610 may abstract resources and functions to connect the computing device 102 with other computing devices. The platform 610 may also serve to abstract scaling of resources to provide a corresponding level of scale to encountered demand for the content services 612 that are implemented via the platform 610. Accordingly, in an interconnected device embodiment, implementation of functionality of the functionality described herein may be distributed throughout the system 600. For example, the functionality may be implemented in part on the computing device 102 as well as via the platform 610 that abstracts the functionality of the cloud 608.

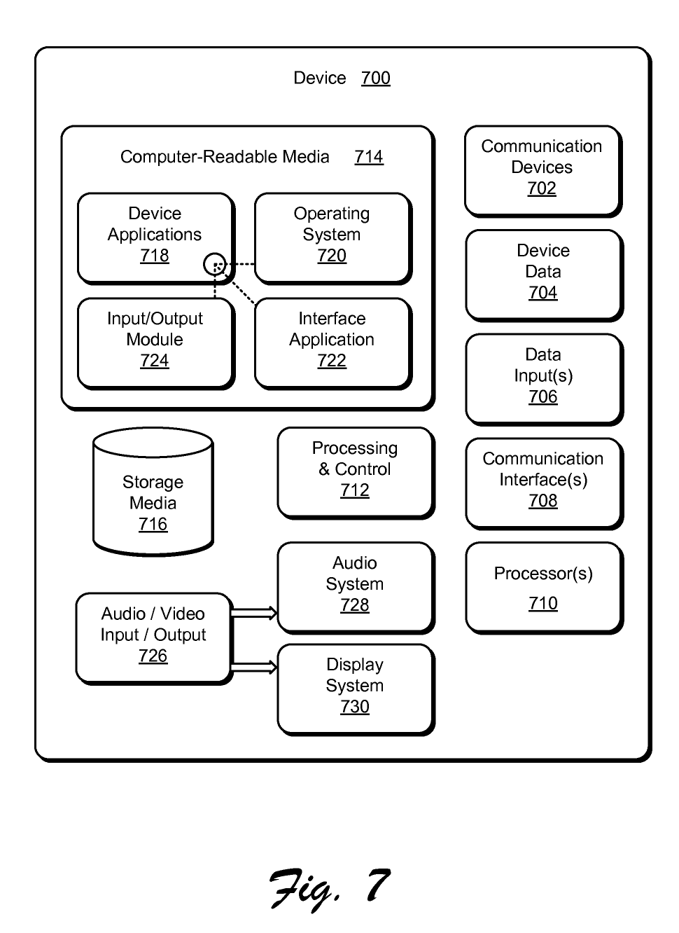

FIG. 7 illustrates various components of an example device 700 that can be implemented as any type of computing device as described with reference to FIGS. 1, 2, and 6 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and an input/output module 724 that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof. Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving an input by a computing device to cause output of an animation involving movement in a user interface; and
responsive to the receiving of the input, exposing an endpoint to software of the computing device that is associated with the user interface, the endpoint referencing a particular location in the user interface at which the animation is calculated to end for the input.

2. A method as described in claim 1, wherein the exposing is performed during the output of the animation by the computing device.

3. A method as described in claim 1, wherein the software is an application or control that is executed by the computing device.

4. A method as described in claim 1, wherein the animation involves a display of inertia such that the movement in the user interface is configured to continue after provision of the input.

5. A method as described in claim 1, wherein the exposing is performed before the particular location in the user interface referenced by the endpoint is output for display in the user interface by the computing device.

6. A method as described in claim 1, further comprising adjusting the endpoint responsive to data received from the software to change the endpoint of the animation from the particular location to another location in the user interface.

7. A method as described in claim 1, further comprising prioritizing fetching and rendering of content associated with the endpoint by the software responsive to the exposing.

8. A method as described in claim 1, wherein the exposing is performed via an application programming interface.

9. A method as described in claim 1, wherein the input is a gesture.

10. A method as described in claim 9, wherein the gesture is detected by the computing device using touch functionality or a camera.

11. A system comprising:
an input device; and
one or more modules implemented at least partially in hardware and communicatively coupled to the input device, the one or more modules configured to recognize an input detected using the input device as a gesture that is configured to initiate an animation involving movement in a user interface, calculate an endpoint that describes a particular location in the user interface at which the movement is to end for the input, and expose the calculated input to software that is associated with causing the user interface to be generated.

12. A system as described in claim 11, wherein the movement of the animation involves inertia.

13. A system as described in claim 11, wherein the one or more modules are configured to expose the endpoint via an application programming interface.

14. A system as described in claim 13, wherein the application programming interface is accessible via a pull model such that application programming interface is configured to be queried by the software.

15. One or more computer-readable storage media comprising computer-executable instructions that, responsive to execution on a computing device, causes the computing device to recognize an input as a gesture configured to cause output of an animation involving movement having inertia and responsive to the recognition of the input, initiate output of the animation for display in a user interface by the computing device and expose an endpoint for the animation to software associated with generating the user interface, the endpoint describing a particular location in the user interface at which the movement is to end for the animation.

16. One or more computer-readable storage media as described in claim 15, wherein the endpoint is configured to be exposed via an application programming interface.

17. One or more computer-readable storage media as described in claim 16, wherein the application programming interface is accessible via a pull model such that application programming interface is configured to be queried by the software.

18. One or more computer-readable storage media as described in claim 15, wherein the instructions are further configured to adjust the endpoint responsive to data received from the software to change the endpoint of the animation from the particular location to another location in the user interface.

19. One or more computer-readable storage media as described in claim 15, wherein the instructions are further configured to cause the software to prioritize fetching and rendering of content associated with the endpoint responsive to the exposure of the endpoint.

20. One or more computer-readable storage media as described in claim 15, wherein the software is an application or control that is executed by the computing device.
